(19) United States
(12) Patent Application Publication
(10) Pub. No.: US 2025/0386289 A1
(43) Pub. Date: Dec. 18, 2025

(54) MULTICAST MBS RECEPTION IN THE RRC INACTIVE STATE

(71) Applicant: Apple Inc., Cupertino, CA (US)

(72) Inventors: Fangli Xu, Beijing (CN); Zhibin Wu, Los Altos, CA (US); Yuqin Chen, Beijing (CN); Dawei Zhang, Saratoga, CA (US); Haijing Hu, Los Gatos, CA (US); Chunhai Yao, Beijing (CN); Naveen Kumar R Palle Venkata, San Diego, CA (US)

(21) Appl. No.: 18/878,956

(22) PCT Filed: Jul. 11, 2022
(86) PCT No.: PCT/CN2022/104903

§ 371 Date: Dec. 26, 2024

(51) Int. Cl. H04W 48/20; H04W 76/27; H04W 76/40

(52) U.S. Cl. CPC H04W 48/20; H04W 76/27; H04W 76/40

(57) ABSTRACT

Techniques discussed herein can facilitate multicast and broadcast services (MBS) in the radio resource control (RRC) inactive state. One example aspect is a baseband processor of a user equipment (UE), including one or more processors configured to receive a suspend configuration in a radio resource control (RRC) message. The one or more processors further configure the UE for a RRC inactive state based on the suspend configuration and receive a multicast and broadcast services (MBS) session configuration before or after configuring the RRC inactive state. The one or more processors further configure multicast MBS reception based on the MBS session configuration; and receive multicast MBS data based on the MBS session configuration while the UE is configured for the RRC inactive state.

### FIELD

The present disclosure relates to wireless technology including New Radio (NR) radio multicast and broadcast services (MBS).

### BACKGROUND

Mobile communication in the next generation wireless communication system, 5G, or new radio (NR) network will provide ubiquitous connectivity and access to information, as well as the ability to share data, around the globe. 5G networks and network slicing will be a unified, service-based framework that will target to meet versatile, and sometimes conflicting, performance criteria. 5G networks will provide services to vastly heterogeneous application domains ranging from Enhanced Mobile Broadband (eMBB) to massive Machine-Type Communications (mMTC), Ultra-Reliable Low-Latency Communications (URLLC), and other communications. In general, NR will evolve based on third generation partnership project (3GPP) long term evolution (LTE)-Advanced technology with additional enhanced radio access technologies (RATs) to enable seamless and faster wireless connectivity solutions.

### BRIEF DESCRIPTION OF THE DRAWINGS

FIG. 1 is an exemplary block diagram illustrating an example of user equipment(s) (UEs) communicatively coupled to a network in accordance with various aspects described herein.

FIGS. 2-4 illustrates diagrams of multicast and broadcast services (MBS) signaling in the radio resource control (RRC) inactive state with dedicated signaling between a base station (BS) and a UE.

FIGS. 5-6 illustrates diagrams of MBS signaling in the RRC inactive state with broadcast signaling between a BS and a UE.

FIGS. 7-8 illustrates diagrams of MBS signaling in the RRC inactive state with multicast signaling of activation or deactivation of the MBS session.

FIGS. 9-11 illustrates diagrams of MBS signaling in the RRC inactive state according to a small data transmission (SDT) procedure.

FIG. 12 illustrates a diagram of MBS signaling in the RRC inactive state where the UE can receive MBS data before and after changing cells.

FIG. 13 illustrates diagram of MBS signaling in the RRC inactive state where the UE fails to receive the MBS session configuration.

FIG. 14 illustrates a flow diagram of an example method for MBS signaling in the RRC inactive state for a UE.

FIG. 15 illustrates a flow diagram of an example method for MBS signaling in the RRC inactive state for a BS.

FIG. 16 illustrates an example of an infrastructure equipment, in accordance with various aspects disclosed.

FIG. 17 illustrates an example of a UE or BS platform, in accordance with various aspects disclosed.

### DETAILED DESCRIPTION

As New Radio (NR) fifth generation (5G) and future communication standards develop, network flexibility and scalability can adapt enhanced performance protocols, for example, multicast and broadcast services (MBS). MBS can deliver services such as vehicle to everything (V2X), emergency and public safety applications, live video delivery, internet of things (IoT) applications, and the like in an efficient manner particularly when user equipment's (UEs) receive the same content. While MBS can be deployed for the radio resource control (RRC) connected state, enhancements to MBS are needed for MBS RRC inactive state operations. MBS in the RRC connected state may not be power efficient and may not fulfill use requirements for mission critical services in cells with a large number of UEs. MBS operations in the RRC inactive state can provide the benefit of lower power operations, and extends multicast support for UEs to realize improved resource efficiency in radio access network (RAN) sharing scenarios.

Various aspects of the present disclosure are directed towards multicast MBS reception in the RRC inactive state. Mechanisms by which a UE can directly receive MBS data upon entering the RRC inactive state are presented herein. For example, when the UE and a base station (BS) enable and support MBS, and a MBS session associated with the UE is activated, the UE may directly receive MBS data upon transitioning to the RRC inactive state.

Mechanisms by which MBS can be enabled or disabled in the RRC inactive state are presented herein. For example, the UE may receive dedicated or broadcast RRC signaling that enables MBS reception in the RRC inactive state. The dedicated RRC signaling may include a MBS session configuration which the UE uses for MBS data reception after transitioning to the RRC inactive state. Furthermore, the UE can receive an MBS activation or deactivation notification while the UE is in a RRC connected or inactive state enabling or disabling MBS reception in the RRC inactive state.

Mechanisms by which the BS provisions the MBS session configuration in the RRC inactive state through dedicated or broadcast signaling is presented herein. For example, the UE can receive dedicated signaling of the MBS session configuration provided in the RRC connected state, provided in a RRC release or RRC suspend configuration message, or received in response to small data transmission (SDT) request from the UE. The UE can receive a broadcast signaling of the MBS session configuration through a system information block (SIB) or a MBS control channel (MCCH) message while the UE is in the RRC inactive state.

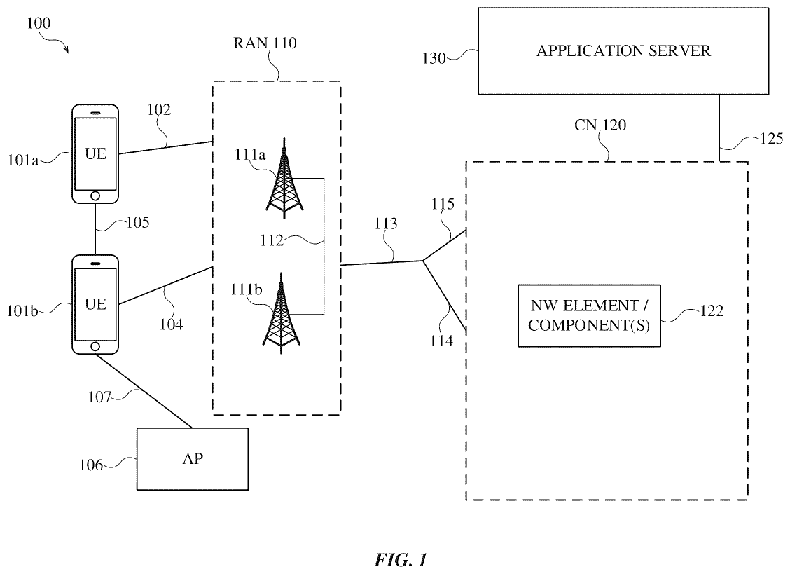

FIG. 1 illustrates example architecture of a wireless communication system 100 of a network that includes UE 101a and UE 101b (collectively referred to as “UEs 101” or “UE 101”), a radio access network (RAN) 110, and a core network (CN) 120. The UEs communicate with the CN 120 by way of the RAN 110. In aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system 100, and the term “E-UTRAN” or the like can refer to a RAN 110 that operates in an LTE or 4G system 100. The UEs 101 utilize connections (or channels) 102 and 104, respectively, each of which comprises a physical communication interface/layer. Channels 102 and 104 can facilitate one or more of licensed or unlicensed communication bands between the UE 101 and the RAN 110.

Alternatively, or additionally, each of the UEs 101 can be configured with dual connectivity (DC) as a multi-RAT or multi-Radio Dual Connectivity (MR-DC), where a multiple Rx/Tx capable UE may be configured to utilize resources provided by two different nodes (e.g., 111a, 111b, 112, or other network nodes) that can be CONNECTED via non-ideal backhaul, one providing NR access and the other one providing either E-UTRA for LTE or NR access for 5G, for example.

Alternatively, or additionally, each of the UEs 101 can be configured in a CA mode where multiple frequency bands are aggregated amongst component carriers (CCs) to increase the data throughput between the UEs 101 and the nodes 111a, 111b. For example, UE 101a can communicate with node 111a according to the CCs in CA mode. Furthermore, UE 101a can communicate with nodes 111 in a DC mode simultaneously and additionally communicate with each node of nodes 111 in the CA mode.

In this example, the connections 102 and 104 are illustrated as an air interface to enable communicative coupling. In aspects, the UEs 101 can directly exchange communication data via a ProSe interface 105. The ProSe interface 105 can alternatively be referred to as a sidelink (SL) interface 105 and can comprise one or more logical channels. In other aspects, the ProSe interface 105 can be a direct (peer-to-peer) communication.

The RAN 110 can include one or more access nodes or RAN nodes 111a and 111b (collectively referred to as “RAN nodes 111” or “RAN node 111”) that enable the connections 102 and 104. As used herein, the terms “access node,” “access point,” or the like can describe equipment that provides the radio baseband functions for data and/or voice connectivity between a network and one or more users. These access nodes can be referred to as a base station (BS), next generation base station (gNBs), RAN nodes, evolved next generation base station (eNBs), NodeBs, RSUs, Transmission Reception Points (TRxPs) or TRPs, and so forth.

In aspects where the system 100 is a 5G or NR system, the interface 112 can be an Xn interface 112. The Xn interface is defined between two or more RAN nodes 111 (e.g., two or more gNBs and the like) that connect to 5GC 120, between a RAN node 111 (e.g., a gNB) connecting to 5GC 120 and an eNB, and/or between two eNBs connecting to 5GC 120.

The UE 101 can receive the MBS session configuration, MBS enable indication, or the MBS activation or deactivation notification from the BS 111. Furthermore, the UE 101 can receive the multicast MBS reception (e.g., MBS data) from the BS 111 while the UE 101 is in the RRC inactive state.

The UE 101 and the RAN node 111 may utilize a Uu interface to exchange control plane data via a protocol stack comprising the PHY layer (e.g., layer 1 (L1)), the MAC layer (e.g., layer 2 (L2)), the RLC layer, the PDCP layer, and the RRC layer (e.g., layer 3 (L3)). The Uu interface can be one or more of connections 102 and 104.

In aspects, the CN 120 can be a 5GC (referred to as “5GC 120” or the like), and the RAN 110 can be CONNECTED with the CN 120 via a next generation (NG) interface 113. In aspects, the NG interface 113 can be split into two parts, a NG user plane (NG-U) interface 114, which carries traffic data between the RAN nodes 111 and a User Plane Function (UPF), and the S1 control plane (NG-C) interface 115, which is a signaling interface between the RAN nodes 111 and Access and Mobility Management Functions (AMFs).

In aspects, where CN 120 is an evolved packet core (EPC) (referred to as “EPC 120” or the like), the RAN 110 can be CONNECTED with the CN 120 via an S1 interface 113. In aspects, the S1 interface 113 can be split into two parts, an S1 user plane (S1-U) interface 114, which carries traffic data between the RAN nodes 111 and the S-GW, and the S1-MME interface 115, which is a signaling interface between the RAN nodes 111 and MMEs.

The UE 101 can receive signaling, for example, MBS data from the BS 111 by connections 102 or 104. Furthermore, the UE 101 can perform the SDT procedure or RRC resume procedure over connections 102 or 104.

The RAN 110 is shown to be communicatively coupled to a core network—in this aspect, CN 120. The CN 120 can comprise a plurality of network components 122 (or network devices), which are configured to offer various data and telecommunication services to customers/subscribers (e.g., users of UEs 101) that are CONNECTED to the CN 120 via the RAN 110.

### Multicast MBS Reception in the RRC Inactive State

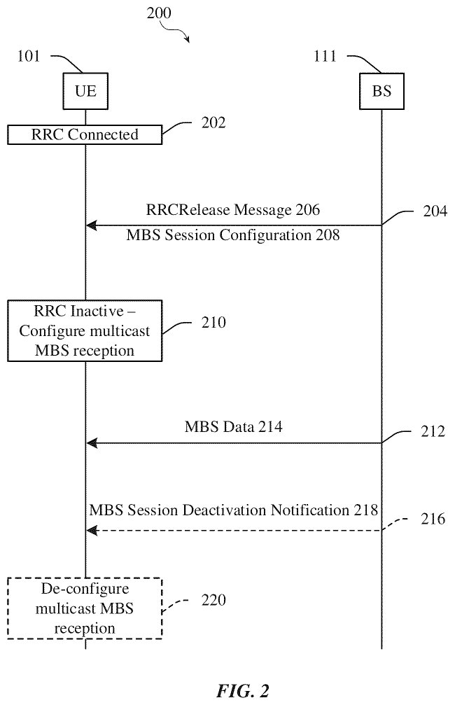

FIGS. 2-4 illustrates diagrams 200-400 of multicast and broadcast services (MBS) signaling in the radio resource control (RRC) inactive state with dedicated signaling between a BS 111 and a UE 101. In diagrams 200-400, the UE 101 can be the UE 101a or UE 101b of FIG. 1. The BS 111 can be the BS 111a or the BS 111b of FIG. 1. For the UE 101 to receive multicast data (e.g., MBS data 214) in the RRC inactive state, one or more conditions may be met. For example, the one or more conditions may include that the UE 101 supports MBS reception in the RRC inactive state. The UE 101 can determine and configure RRC inactive state MBS reception according to a capability of the UE 101. In similar or other examples, the one or more conditions may include that the BS 111 supports MBS data 214 transmission while the UE 101 is in the RRC inactive state. The BS 111 may support MBS data 214 transmission and enable the feature. In similar or other examples, the one or more conditions may include that a MBS session associated with the UE 101 is activated. The UE 101 may consider the MBS session activation based on pre-conditions or the UE 101 may receive a MBS session activation notification.

The example shown in diagram 200 presumes the one or more conditions include at least that the UE 101 supports MBS reception in the RRC inactive state and that the BS 111 supports MBS data 214 transmission while the UE 101 is in the RRC inactive state. At 202 the UE 101 can be in a RRC connected state with the BS 111. At 204, the BS 111 can generate and transmit a RRCRelease message 206 to the UE 101. The RRCRelease message 206 includes a suspend configuration (SuspendCfg) and is sent in a RRC message. In some aspects, the RRC message can be a dedicated RRC message for the UE 101. The RRC message that includes the RRCRelease message 206 with the suspend configuration further includes a MBS session configuration 208. The MBS session configuration 208 configured by the BS 111 communicates to the UE 101 the configuration for multicast MBS reception and an associated session for multicast MBS reception. As such, the MBS session configuration 208 can include one or more information elements such as a MBS session ID identifying the MBS session and associated internet protocol (IP) multicast addresses, frequencies for the MBS session, and other associated information elements.

After the UE 101 receives the suspend configuration in the RRC message, the UE 101 is configured for a RRC inactive state based on the suspend configuration at 210. Furthermore, the UE 101 can determine that reception of the MBS session configuration 208 at 204 is an indication that the MBS session is active (e.g., a MBS session activation notification). In this aspect, the UE 101 can configure multicast MBS reception based on the MBS session configuration at 210. It is noted that the order of configuring multicast MBS reception can be different, for example, configuration of multicast MBS reception can occur before, during, or after the RRC inactive state configuration.

After the UE 101 configures the RRC inactive state and configures multicast MBS reception based on the MBS session configuration 208, the UE 101 can receive MBS data 214 at 212. The MBS data 214 is associated with the MBS session ID identified by the MBS session configuration 208. In this aspect, the BS 111 generates and transmits MBS data 214 to the UE 101 at 212. The MBS data 214 can be transmitted by the BS 111 and received by the UE 101 in a MBS traffic channel (MTCH). The MBS data 214 can, for example, be or comprise various service data such as V2X, emergency or public safety data, live video, IoT data, or the like. Furthermore, the BS 111 can transmit the MBS data 214 to one or more UEs that include UE 101. As such, MBS data 214 is received by the UE 101 while the UE 101 is configured for the RRC inactive state.

In some aspects, the BS 111 may determine to deactivate the MBS session, as such, the BS 111 may generate and transmit a MBS session deactivation notification 218 at 216. The MBS session deactivation notification 218 can indicate to the UE 101 that multicast MBS reception in the RRC inactive state is de-activated. The MBS session deactivation notification 218 is associated with the MBS session ID identified by the MBS session configuration 208. In response to the MBS session deactivation notification 218, the UE 101 can de-configure multicast MBS reception at 220. The MBS session deactivation notification 218 can be comprised in a system information block (SIB), a dedicated message such as a RRC message, a paging message, or a MBS control channel (MCCH) message. Alternatively, the UE 101 may de-configure multicast MBS reception at 220 when changing cells (e.g., cell reselection procedure), when MBS data 214 is not received within a corresponding time period, or according to a broadcast configuration. For example, the UE 101 may configure a MBS timer and reception time threshold and de-configure multicast MBS reception at 220 when MBS data 214 is not received before the MBS timer exceeds the reception time threshold.

Aspects described in FIG. 2 provide mechanism for RRC inactive state MBS reception according to dedicated MBS signaling from the BS 111. This aspect describes dedicated MBS session configuration 208 signaling where the UE 101 is configured for multicast MBS reception in the RRC inactive state without additional MBS session activation signaling from the BS 111. As such, the BS 111 can configure RRC inactive state MBS services (e.g., MBS session configuration 208, MBS session deactivation notification 218) for specific UEs (e.g., UE 101) according to dedicated signaling and the UE 101 can conserve resources by autonomously determining the MBS session is active without additional signaling. Further examples are described herein that provide solutions for RRC inactive state MBS reception for various network configurations.

Diagram 300 illustrates alternative features relative to diagram 200 of FIG. 2 where the UE 101 receives a MBS session activation notification 304 after configuring the RRC inactive state, and where the UE 101 can de-configure multicast MBS reception in response to a broadcast configuration 310.

After the UE 101 configures the RRC inactive state at 210, the BS 111 can generate and transmit a MBS session activation notification 304 at 302 to the UE 101. The MBS session activation notification 304 can be dedicated signaling for UE 101 and indicates to the UE 101 that the BS 111 supports RRC inactive state communications. After the UE 101 receives the MBS session activation notification 304, the UE 101 can configure multicast MBS reception at 306 according to the MBS session configuration 208. In this aspect, the MBS session activation notification 304 corresponds to the MBS session ID identified by the MBS session configuration 208.

The UE 101 can receive the MBS data 214 at 212 after configuring multicast MBS reception at 306. In some aspects, the BS 111 may determine to deactivate the MBS session, as such, the BS 111 may generate and transmit a broadcast configuration 310 at 308. The UE 101 can determine to de-configure multicast MBS reception at 220. The broadcast configuration 310 may comprise the MBS session deactivation notification 218 of FIG. 2, or may be MBS signaling that overrides the dedicated MBS session configuration 208. In some aspects, the broadcast configuration 310 does not include an IE with the MBS session ID associated with the MBS session configuration 208. When the UE 101 detects that the broadcast configuration 310 does not include MBS session ID associated with the MBS session configuration 208, the UE 101 can determine to de-configure multicast MBS reception at 220. The broadcast configuration can be comprised in a SIB or a MCCH message, and may be a dedicated message. Alternatively, the UE 101 may de-configure multicast MBS reception at 220 according to the features discussed at 216 of FIG. 2.

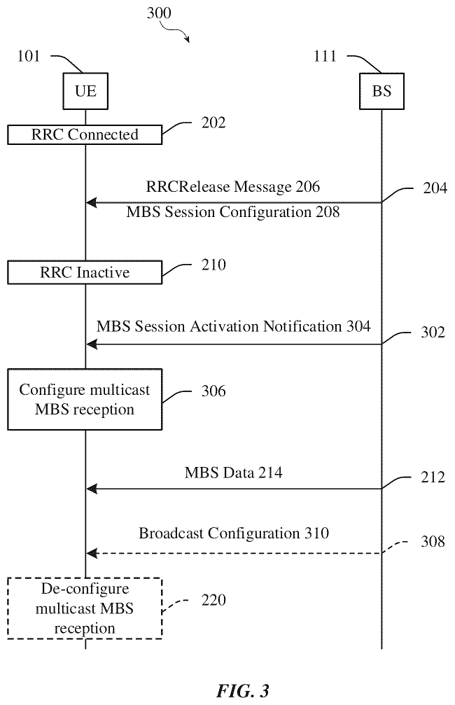

Aspects described in FIG. 3 provide mechanism for RRC inactive state MBS reception according to dedicated MBS signaling from the BS 111. Diagram 300 describes dedicated MBS session configuration 208 signaling where the UE 101 is configured for multicast MBS reception in the RRC inactive state according to a MBS session activation notification 304 from the BS 111. As such, the BS 111 has flexibility in configuring RRC inactive state MBS services such as the MBS session configuration 208 and MBS session activation/deactivation for specific UEs (e.g., UE 101).

Diagram 400 illustrates alternative features relative to diagram 200 of FIG. 2 where the UE 101 can receive a MBS session activation notification 304 with the RRC message at 204, and where the UE 101 can de-configure multicast MBS reception in response to changing cells.

At 204, the BS 111 can generate and transmit the RRCRelease message 206 to the UE 101. The RRCRelease message 206 includes a suspend configuration (SuspendCfg) and is sent in a RRC message. In some aspects, the RRC message can be a dedicated RRC message for the UE 101. In some aspects, the RRC message that includes the RRCRelease message 206 with the suspend configuration further includes the MBS session configuration 208 and the UE 101 can determine that reception of the MBS session configuration 208 is an indication that the MBS session is active (implicit notification) as described at 204 of FIG. 2. In alternative aspects, the RRC message that includes the RRCRelease message 206 with the suspend configuration further includes the MBS session configuration 208 and a MBS session activation notification 304. In this aspect, the UE 101 determines MBS session activation by the BS 111 generating and transmitting the MBS session activation notification 304 (explicit notification). Thus the UE 101 can determine implicitly or explicitly that the MBS session is active while the UE 101 is in the RRC connected state.

At 210 the UE 101 can configure the RRC inactive state and configure multicast MBS reception. After configuring multicast MBS reception, the UE 101 can receive MBS data 214 at 212. The UE 101 can determine to de-configure multicast MBS reception at 406 according to aspects described in FIGS. 2-3. Alternatively, the UE 101 can determine to de-configure multicast MBS reception at 406 in response to a cell change procedure at 402. For example, the UE 101 can perform a cell reselection procedure and connect to a new BS 111b (e.g., BS 111b of FIG. 1). In some aspects, the UE 101 can connect to the new BS 111b based on an indication in a SIB message received from BS 111. After changing cells at 402, the UE 101 can receive a broadcast message from the new BS 111b at 404. The broadcast message from the new BS 111b may indicate that RRC inactive state MBS reception is deactivated, or may not indicate RRC inactive state MBS resources, or may not indicate RRC inactive state MBS resources for a session ID associated with the MBS session configuration 208. In this aspect, the UE 101 may determine to de-configure multicast MBS reception at 406 in response to the broadcast message from the new BS at 404.

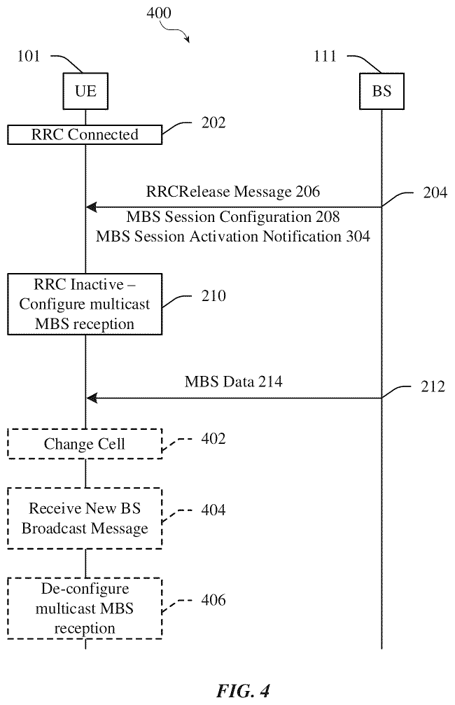

Aspects described in FIG. 4 provide mechanism for RRC inactive state MBS reception according to dedicated MBS signaling from the BS 111. Diagram 400 describes dedicated MBS session configuration 208 signaling where the UE 101 is configured for multicast MBS reception in the RRC inactive state according to MBS session activation determined from the RRC message at 204. In one aspect, the BS 111 has flexibility in explicitly configuring MBS session activation based on the MBS session activation notification. In another aspect, the UE 101 implicitly determines the MBS session is activated based on receiving the MBS session configuration 208. In either aspect, the UE 101 determines that the MBS session is activated while the UE 101 is in the connected state and the UE 101 can directly receive MBS data 214 upon configuring the RRC inactive state without additional signaling. Mechanisms by which the UE 101 can de-configure multicast MBS reception at 406 are presented based on a cell change. While FIGS. 2-4 describe specific mechanisms for the UE 101 to de-configure multicast MBS reception, it is appreciated that mechanisms for de-configuring multicast MBS reception are interchangeable between FIGS. 2-4.

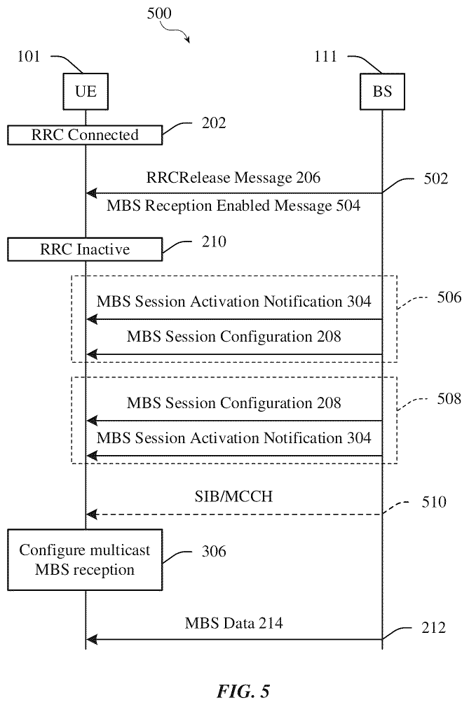

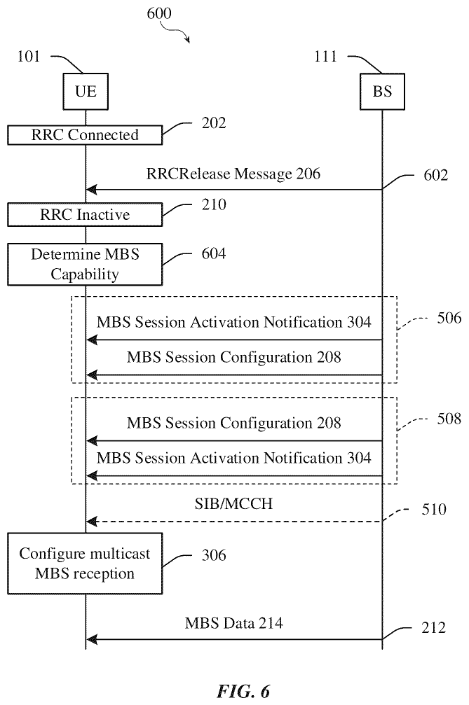

FIGS. 5-6 illustrates diagrams 500-600 of MBS signaling in the RRC inactive state with broadcast signaling between a BS 111 and a UE 101. In diagrams 500-600, the UE 101 can be the UE 101a or UE 101b of FIG. 1. The BS 111 can be the BS 111a or the BS 111b of FIG. 1. In diagrams 500-600, presumes the one or more conditions include at least that the UE 101 supports MBS reception in the RRC inactive state and that the BS 111 supports MBS data 214 transmission while the UE 101 is in the RRC inactive state. The BS 111 can generate and transmit the MBS session configuration 208 by broadcast signaling, for example, broadcast SIB, MCCH messaging, RRC messaging, or the like. In some aspects the UE 101 is notified that MBS reception is enabled by the BS 111 while the UE 101 is in the RRC connected state, then receive a MBS session activation notification 304 and MBS session configuration 208 when the UE 101 is in the RRC inactive state. In other aspects, the UE 101 determines a MBS capability of the UE 101, and receives the MBS session activation notification 304 and the MBS session configuration 208 based on the MBS capability of the UE 101.

Diagram 500 shows an example where MBS signaling for the RRC inactive state is enabled while the UE 101 is in the RRC connected state. In diagram 500, the UE 101 receives the RRCRelease message 206 at 502 from the BS 111. The RRCRelease message 206 includes the suspend configuration and is sent to the UE 101 in a RRC message. The RRC message can further include a MBS reception enabled message 504 indicating that MBS services for the RRC inactive state are enabled by the BS 111. As such, the BS 111 can generate and transmit the RRC message comprising the MBS reception enabled message 504. After receiving the RRC message with the RRCRelease message 206 and the MBS reception enabled message 504 at 502, the UE 101 can configure the RRC inactive state at 210. Aspects of act 210 correspond to act 210 of FIG. 3.

After the UE 101 is configured for the RRC inactive state, the UE can receive the MBS session configuration 208 from the BS 111 either upon entering the RRC inactive state or after receiving the MBS session activation notification 304 from the BS 111.

For example, at 506 the UE 101 receives the MBS session activation notification 304 corresponding to a MBS session ID, and subsequently receives the MBS session configuration 208 that corresponds to the MBS session ID. Alternatively, at 508, the UE 101 receives the MBS session configuration 208 corresponding to the MBS session ID upon entering the RRC inactive state, and subsequently receives the MBS session activation notification 304 that corresponds to the MBS session ID. The MBS session activation notification 304 and the MBS session configuration 208 at 506 and 508 are both generated and transmitted by the BS 111 to the UE 101 while the UE 101 is in the RRC inactive state, and can be configured in a broadcast signaling, for example, a broadcast SIB or a broadcast MCCH. Furthermore, the UE 101 can reserve resource for MBS reception in the RRC inactive state when the MBS reception enabled message 504 is received. The UE 101 can conserve resources associated with receiving one or more of the MBS session activation notification 304 or MBS session configuration 208 when the MBS reception enabled message 504 is not received.

Alternatively or additionally, the SIB or MCCH signaling associated with acts 506 and 508 can indicate deactivation of the multicast MBS session, and the UE 101 can de-configure multicast MBS reception accordingly.

In an alternative example, at 510 the UE 101 receives a SIB or MCCH message from the BS 111. If the SIB or MCCH message at 510 includes the MBS session configuration 208, the UE 101 can determine that the MBS session is activated. In this aspect, the SIB or MCCH message at 510 is analogous to the MBS session activation notification 304 at 506 or 508. If the SIB or MCCH message at 510 does not include the MBS session configuration 208, the UE 101 can determine that the MBS session is deactivated.

After receiving the MBS session configuration 208 at either 506, 508, or 510, the UE 101 can configure multicast MBS reception at 306 and receive MBS data 214 associated with the session ID of the MBS session configuration 208 at 212. Aspects of act 306 correspond to act 306 of FIG. 3 and aspects of act 212 correspond to act 212 of FIG. 2. If the UE 101 receives the SIB or MCCH message at 510 without the MBS session configuration 208, the UE 101 can determine that the MBS session associated with the MBS session configuration 208 is deactivated, and de-configure multicast MBS reception. Furthermore, the UE 101 can determine to de-configure multicast MBS reception according to acts 402, 404, and 406 of FIG. 4, acts 308 and 220 of FIG. 3, or acts 216 and 220 of FIG. 2. Diagram 500 provides a mechanism where the BS 111 can enable the UE 101 to receive the MBS session configuration 208 while the UE 101 is in the RRC inactive state.

Diagram 600 shows an example where the UE 101 determines to receive the MBS session configuration 208 based on a MBS capability of the UE 101. The UE 101 receives the RRCRelease message 206 at 602 from the BS 111 while the UE 101 is in the RRC connected state. The RRCRelease message 206 includes the suspend configuration and is sent to the UE 101 in a RRC message. After receiving RRC message with the RRCRelease message 206 at 602, the UE 101 can configure the RRC inactive state at 210. Aspects of act 210 correspond to act 210 of FIG. 3.

After the UE 101 is in the RRC inactive state, the UE 101 can determine a MBS capability of the UE 101. In this aspect, the UE 101 determines if the UE 101 fulfils a criteria for RRC inactive state reception. For example, in some aspects, the MBS capability of the UE 101 is determined based on whether or not the UE 101 has the capability to receive the multicast MBS in the inactive state. If the UE 101 determines that the UE 101 does not fulfill the criteria for RRC inactive state reception, the UE 101 will not receive the MBS session configuration 208 (e.g. at acts 506, 508, or 510), and thus will not configure multicast MBS reception or receive MBS data 214. If the 101 does fulfill the criteria for RRC inactive state reception, then the UE 101 can determine to receive the MBS session activation notification 304. For example, the MBS session activation notification 304 can be received at acts 506, 508, or 510 as described in FIG. 5, then configure multicast MBS reception at 306 and receive MBS data 214 at 212 while the UE 101 is in the RRC inactive state. Furthermore, the UE 101 can determine to de-configure multicast MBS reception according to acts 402, 404, and 406 of FIG. 4, acts 308 and 220 of FIG. 3, or acts 216 and 220 of FIG. 2. Diagram 600 minimizes signaling from the BS 111 and provides a mechanism where the UE 101 can determine if the UE 101 can be enabled for RRC inactive state MBS reception.

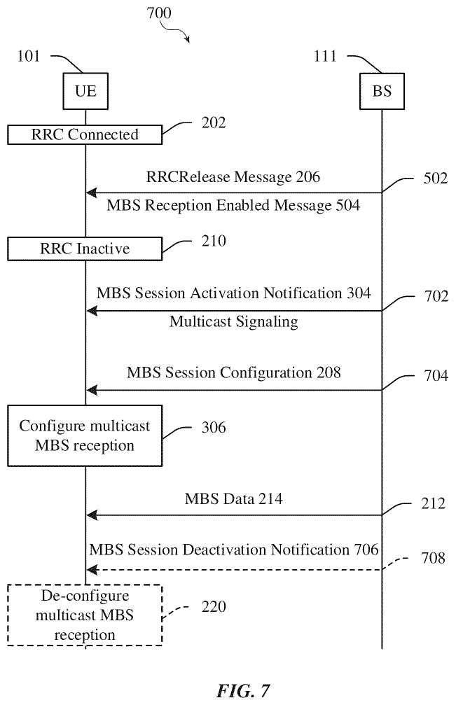

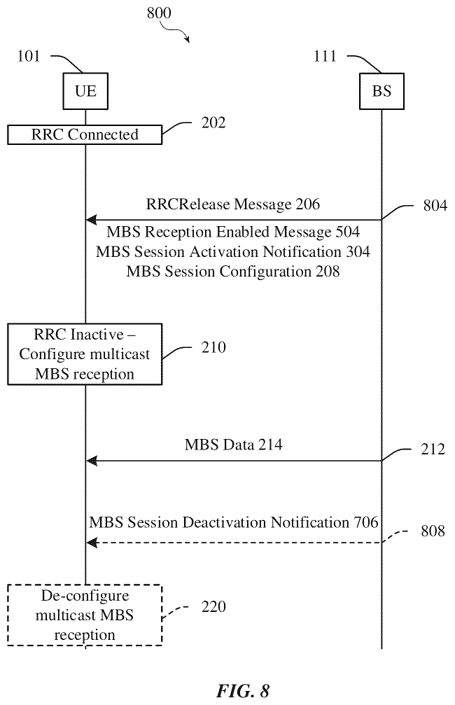

FIGS. 7-8 illustrates diagrams 700-800 of MBS signaling in the RRC inactive state with multicast signaling of activation or deactivation of the MBS session. In diagrams 700-800, the UE 101 can be the UE 101a or UE 101b of FIG. 1. The BS 111 can be the BS 111a or the BS 111b of FIG. 1. Diagrams 700-800, presumes the one or more conditions include at least that the UE 101 supports MBS reception in the RRC inactive state and that the BS 111 supports MBS data 214 transmission while the UE 101 is in the RRC inactive state. The BS 111 can generate and transmit the MBS session activation notification 304 by multicast signaling while the UE 101 is in the RRC inactive state after transmitting the MBS reception enabled message 504 while the UE 101 is in the RRC connected state. Multicast signaling can include a multicast SIB, multicast paging, multicast MCCH signaling or the like.

The BS 111 can generate and transmit the MBS session configuration 208 by broadcast signaling, for example, broadcast SIB, MCCH messaging, RRC messaging, or the like. In some aspects the UE 101 is configured to enable MBS reception by the BS 111 while the UE 101 is in the RRC connected state, then receive a MBS session activation notification 304 and MBS session configuration 208 when the UE 101 is in the RRC inactive state.

Diagram 700 shows an example where the UE 101 receives a MBS reception enabled message 504 in the RRC connected state, and receives the MBS session activation notification 304 through multicast signaling. The UE 101 receives the RRCRelease message 206 at 502 according to an RRC message. The RRC message can further include a MBS reception enabled message 504 indicating that MBS services for the RRC inactive state are enabled by the BS 111. Aspects of 502 correspond to features described in accordance with FIG. 5 at 502. After receiving the RRC message with the RRCRelease message 206 and the MBS reception enabled message 504 at 502, the UE 101 can configure the RRC inactive state at 210. Aspects of act 210 correspond to act 210 of FIG. 3 or act 210 of FIG. 5.

At 702 the BS 111 generates and transmits the MBS session activation notification 304 to the UE 101. The MBS session activation notification 304 can be signaled by multicast signaling. For example, the MBS session activation notification 304 can be signaled by a multicast SIB message, a multicast paging message, a multicast RRC message, a multicast MCCH message or the like. In this aspect, the BS 111 can indicate to a group of UEs, that can include UE 101, that the MBS session is activated. The BS 111 can generate and transmit a MBS session configuration 208 at 704 with a session ID corresponding with the session ID of the MBS session activation notification 304. In some aspects, the MBS session configuration 208 can be generated by the BS 111 in a multicast message similar to the MBS session activation notification 304 at 702. In other aspects, the MBS session configuration 208 at 704 is generated and transmitted by the BS 111 and received by the UE 101 according to dedicated signaling, for example, the dedicated signaling described in FIG. 3. In other aspects, the MBS session configuration 208 at 704 is received before configuring the RRC inactive state at 210 or received in other dedicated or broadcast signaling.

After receiving the MBS session activation notification 304 at 702 and the MBS session configuration 208 at 704, the UE 101 can configure multicast MBS reception at 306. Subsequently, the UE 101 can receive MBS data 214 at 212 from the BS 111. Aspects of act 212 correspond to FIG. 2 at 212. At 708 the BS 111 can generate and transmit a MBS session deactivation notification 706 to the UE 101. After receiving the MBS session deactivation notification 706, the UE 101 can de-configure multicast MBS reception at 220. In this aspect, the MBS session deactivation notification 706 at 708 can be transmitted and received in multicast signaling as describe in accordance with the MBS session activation notification 304 at 702.

In some aspects, the BS 111 can indicate a MBS session status, for example, MBS session activation notification 304 or MBS session deactivation notification 706, in a multicast MCCH transmission. In this aspect, the MBS session status can be indicated by the BS 111 on an interval or per multicast MCCH transmission. As such, the UE 101 can receive a plurality of multicast MCCH transmissions indicating the MBS session status. The UE 101 can configure multicast MBS reception (e.g., as described at 306), when the multicast MCCH message comprises the MBS activation notification. The UE 101 can de-configure multicast MBS reception (e.g., as described at 220), when the multicast MCCH message comprises the MBS deactivation notification.

In some aspects, the BS 111 can indicate the MBS session status, for example in a MBS paging message. In this aspect, the MBS session status can be indicated by the BS 111 on an interval or per MBS paging message. As such, the UE 101 can receive a plurality of MBS paging messages indicating the MBS session status. The UE 101 can configure multicast MBS reception (e.g., as described at 306), when the MBS paging message comprises the MBS activation notification. The UE 101 can de-configure multicast MBS reception (e.g., as described at 220), when the MBS paging message comprises the MBS deactivation notification. In some examples, the MBS paging message is a multicast MBS paging message, or a multicast specific paging message, where the MBS paging message is dedicated to indicating the MBS session status.

In some aspects, the BS 111 can indicate the MBS session status, for example, MBS session activation notification 304 or MBS session deactivation notification 706, in a layer 1 (L1) or layer 2 (L2) multicast MBS indication. In this aspect, the MBS session status can be indicated by the BS 111 on an interval or repetitive basis in the L1 or L2 multicast MBS indication. As such, the UE 101 can receive a plurality of L1 or L2 multicast MBS indications the MBS session status. The UE 101 can configure multicast MBS reception (e.g., as described at 306), when the L1 or L2 multicast MBS indication comprises the MBS activation notification. The UE 101 can de-configure multicast MBS reception (e.g., as described at 220), when the L1 or L2 multicast MBS indication comprises the MBS deactivation notification. In some examples, the L1 or L2 multicast MBS indication is transmitted by the BS 111 through beam sweeping to transmit the L1 or L2 multicast MBS indication to the group of UEs, which can include UE 101. In similar or alternative aspects, the L1 or L2 multicast MBS indication is a MBS medium access control (MAC) control element (CE) indication, and the MBS MAC CE indicates the MBS session information for one or more MBS sessions. In similar or alternative aspects, the MBS MAC CE is transmitted according to L2 signaling.

In some aspects, the BS 111 can determine to activate a MBS session while the UE 101 is in the RRC inactive state for MBS reception in the RRC connected state (not illustrated). For example, after the UE 101 is configured for the RRC inactive state at 210, the UE can receive the MBS session activation notification 304 and the MBS session configuration 208 at 702 and 704. Signaling associated with either of the MBS session activation notification 304 and MBS session configuration 208 can further indicate MBS data 214 reception in the RRC connected state, and thus include a RRC resume indication. The UE 101 can be configured for the RRC connected state based on the RRC resume indication and configure multicast MBS reception based on the MBS session configuration 208. The UE 101 can then receive multicast MBS data (e.g., MBS data 214), based on the MBS session configuration while the UE 101 is configured for the RRC connected state. In this aspect, the UE 101 receives MBS configuration data while configured in the RRC inactive state for MBS data reception that takes place in the RRC connected state. Thus the UE 101 can receive MBS data reception in the RRC connected state immediately without further signaling.

Diagram 800 shows an example where the UE 101 receives the MBS session configuration 208 before entering the RRC inactive state and receives MBS data 214 directly in the RRC inactive state. Furthermore, in diagram 800, the UE 101 can receive the MBS session deactivation notification according to multicast signaling.

In diagram 800 the BS 111 generates and transmits the RRCRelease message 206 at 804 in a RRC message while the UE 101 is in a RRC connected state. In some aspects, the UE 101 can receive RRC inactive state MBS configuration data such as one or more of the MBS reception enabled message 504, MBS session activation notification 304, or the MBS session configuration 208. The RRC inactive state MBS configuration data can be received in multicast, broadcast, or dedicated signaling in accordance with aspects described herein. In some aspects the RRC inactive state MBS configuration data is received in the RRC message at 804, in other aspects the RRC inactive state MBS configuration data can be received in other messaging before configuring the RRC inactive state at 210. In some aspects the BS 111 generates and the UE 101 receives the MBS session configuration 208 and the UE 101 determines that the MBS session is activated based on reception of the MBS session configuration 208. In other aspects the UE 101 receives the MBS session activation notification 304 indicating to the UE that the MBS session is active (e.g. the MBS session according to the MBS session ID common between the MBS session activation notification 304 and the MBS session configuration 208). In yet other aspects the UE 101 receives the MBS reception enabled message 504 notifying the UE 101 that the BS 111 supports RRC inactive state reception, and then the UE 101 receives at least the MBS session configuration 208.

After the UE 101 receives the suspend configuration in the RRC message, the UE 101 is configured for a RRC inactive state based on the suspend configuration at 210. The UE 101 can configure multicast MBS reception based on the MBS session configuration 208 received while the UE 101 is in the RRC connected state. It is noted that the order of configuring multicast MBS reception can be different, for example, configuration of multicast MBS reception can occur before, during, or after the RRC inactive state configuration. After the UE 101 configures the RRC inactive state and configures multicast MBS reception based on the MBS session configuration 208, the UE 101 can receive MBS data 214 at 212. Aspects of 212 correspond to the description of act 212 of FIG. 2.

The UE 101 can receive a MBS session deactivation notification 706 at 808. The MBS session deactivation notification 706 can be received according to multicast signaling as described in accordance with diagram 700 of FIG. 7 at act 708. The UE 101 can also de-configure multicast MBS reception at 220 in accordance with diagram 700 at 220. In some examples, the UE 101 can keep the MBS session configuration 208 after de-configuring multicast MBS reception to use the MBS session configuration 208 for subsequent signaling, for example, if another MBS session activation notification 304 is received. Diagram 800 provides mechanisms by which the UE 101 can directly receive MBS data 214 after entering the RRC inactive state without additional signaling based on the RRC inactive state MBS configuration data received prior to entering the RRC inactive state.

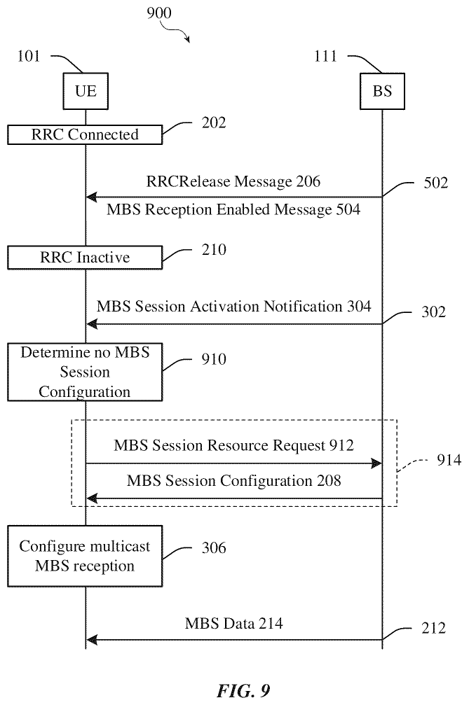

FIGS. 9-11 illustrates diagrams 900-1100 of MBS signaling in the RRC inactive state according to a small data transmission (SDT) procedure. In diagrams 900-1100, the UE 101 can be the UE 101a or UE 101b of FIG. 1. The BS 111 can be the BS 111a or the BS 111b of FIG. 1. Diagrams 900-1100, presumes the one or more conditions include at least that the UE 101 supports MBS reception in the RRC inactive state and that the BS 111 supports MBS data 214 transmission while the UE 101 is in the RRC inactive state. The UE 101 can determine that the UE 101 does not have the MBS session configuration 208 after receiving the MBS session activation notification 304, and subsequently perform the SDT procedure. By performing the SDT procedure, the UE 101 can interrogate the BS 111 for the MBS session configuration 208. In some aspects the UE 101 receives the MBS session configuration 208 and receives MBS data 214 in the RRC inactive state. In other aspects the UE 101 is instructed by the BS 111 to perform a RRC resume procedure and receive MBS data 214 in the RRC connected state. In yet other aspects the UE 101 determines that the SDT procedure failed and autonomously performs a RRC resume or RRC setup procedure and receives MBS data 214 in the RRC connected state.

Diagram 900 shows an example where the UE 101 receives the MBS session activation notification 304 at 302 after configuring the RRC inactive state. Aspects of acts 202, 502, 210, and 302 can correspond to any of FIGS. 2-8. After receiving the MBS session activation notification 304 at 302, the UE 101 can determine if the UE 101 has the MBS session configuration 208 associated with the session ID of the MBS session activation notification 304 at 910. For example, the UE 101 may have received the MBS session configuration 208 in prior RRC inactive state transmissions (e.g., act 508 of FIG. 6), or in prior RRC connected state transmissions (e.g., FIG. 2-4, or 8). If the UE 101 determines that the UE 101 does not have a MBS session configuration associated with the MBS session activation notification 304, the UE 101 can determine to perform a SDT procedure at 914.

As such, while the UE 101 is in the RRC inactive state, the UE 101 can generate and transmit a MBS session resource request 912. In some aspects, the MBS session resource request 912 can be one of a new RRC message, a new MAC CE which is transmitted with a first UL SDT message (e.g., RRCResumeRequest), or a specific RRC resume request message configured with the first UL SDT message. The MBS session resource request 912 may identify the session ID associated with the MBS session activation notification 304. In response, the BS 111 can generate and transmit the MBS session configuration 208 associated with the MBS session activation notification. The UE 101 can configure the multicast MBS reception at 306 according to the MBS session configuration 208 and subsequently receive MBS data 214 at 212. The UE 101 can de-configure multicast MBS reception according to features described herein while the UE 101 is in the RRC connected or RRC inactive states. In this aspect, the UE 101 can receive the MBS session activation notification 304 which may not correspond to a MBS session configuration 208 that the UE 101 previously received. If the UE 101 does not have the MBS session configuration, the UE 101 can interrogate the BS 111 for the MBS session configuration giving the UE 101 the flexibility to request the MBS session configuration 208.

Diagram 1000 shows an example where the UE 101 receives a RRC resume indication 1004 in response to the MBS session resource request 912. This example shows alternative aspects relative to diagram 900 after the UE 101 generates and transmits the MBS session resource request 912 as part of a SDT procedure.

The UE 101 performs a SDT procedure at 1002 after determining that the UE 101 does not have a MBS session configuration associated with the MBS session activation notification 304. The BS 111 can determine that the UE 101 should receive MBS data 214 in the RRC connected state and respond to the MBS session resource request 912 with a RRC resume indication 1004. In some aspects, the BS 111 sends the UE 101 the MBS session configuration 208 with the RRC resume indication 1004. In other aspects, the BS 111 sends the UE 101 the MBS session configuration 208 after transmitting the RRC resume indication 1004 and before the MBS data 214 at 212. The UE 101 configures multicast MBS reception based on receiving the MBS session configuration 208. In response to the RRC resume indication 1004, the UE 101 can perform a RRC resume procedure at 1006, transition to the RRC connected state at 1008, and receive MBS data 214 at 212 while the UE 101 is configured for the RRC connected state. The UE 101 can de-configure multicast MBS reception according to features described herein while the UE 101 is in the RRC connected or RRC inactive states.

Diagram 1000 provides mechanisms by which the UE 101 can request MBS session resources when the UE 101 is lacking a MBS session resource associated with the MBS session activation notification 304 providing the UE 101 flexibility to request configuration information while in the RRC inactive state. Furthermore, the BS 111 has the flexibility to determine if the UE 101 should receive the MBS data 214 while the UE 101 is in the RRC connected state, and indicate both the MBS session configuration 208 and an RRC resume indication 1004 to the UE 101 while the UE 101 is in the RRC inactive state for multicast reception after the UE 101 transitions into the RRC connected state.

Diagram 1100 shows an example where the SDT procedure fails and the UE 101 performs a RRC resume or RRC setup procedure to configure the RRC connected state and receive the MBS session configuration 208. This example shows alternative aspects relative to diagram 1000 after the UE 101 generates and transmits the MBS session resource request 912 as part of a SDT procedure. After the UE 101 transmits the MBS session resource request 912, the SDT procedure fails at 1104. The SDT procedure can fail under a number of conditions, for example, the MBS session resource request 912 may not be received by the BS 111 and the BS 111 does not respond with the MBS session configuration 208 in a designated time period. The BS 111 may receive the MBS session resource request 912 but the MBS session configuration 208 transmitted by the BS 111 in response may not be received by the UE 101 in the designated time period. The SDT procedure can fail if the UE 101 receives a MBS session configuration 208 from the BS 111 in response to the MBS session resource request 912 where the session ID of the MBS session configuration 208 does not correspond to the session ID of the MBS session activation notification 304 at 302.

After detecting that the SDT procedure failed, the UE 101 can perform a RRC resume procedure or a RRC setup procedure at 1106. The UE 101 can receive the MBS session configuration 208 from the BS 111 in response to performing the RRC resume procedure or RRC setup procedure where the MBS session configuration 208 corresponds to a session ID of the MBS session activation notification 304. The UE 101 can configure the RRC connected state at 1008, configure multicast MBS reception according to the MBS session activation notification 304, and receive MBS data 214 at 212 while the UE 101 is in the RRC connected state. The UE 101 can de-configure multicast MBS reception according to features described herein while the UE 101 is in the RRC connected or RRC inactive states. Diagram 1100 provides mechanisms by which the UE 101 can recover a MBS session configuration 208 when the SDT procedure fails by performing the RRC resume or RRC setup procedure.

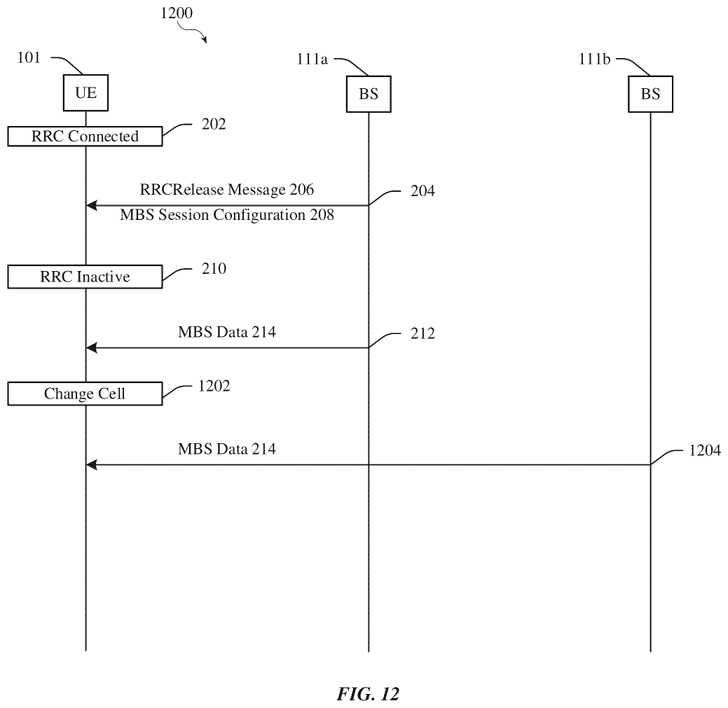

FIG. 12 illustrates diagram 1200 of MBS signaling in the RRC inactive state where the UE 101 can receive MBS data 214 before and after changing cells. In diagram 1200, the UE 101 can be the UE 101a or UE 101b of FIG. 1. Diagram 1200 presents two BSs, for example a first BS 111a and a second BS 111b and can be the nodes or BSs 111a, 111b presented in FIG. 1. In some aspects, the BS 111a is referred to as a serving BS 111a and the second BS 111b is referred to as a new BS 111b. Diagram 1200, presumes the one or more conditions include at least that the UE 101 supports MBS reception in the RRC inactive state and that the BS 111 supports MBS data 214 transmission while the UE 101 is in the RRC inactive state.

Aspects of acts 202, 204, 210, and 212 can correspond to acts described in FIG. 2 or alternatively correspond to acts described in FIGS. 3-11. For example, the UE 101 receives the RRCRelease message 206 at 204 and configures the RRC inactive state at 210. Before the UE 101 receives the MBS data 214 at 212 from the BS 111, the UE 101 at least receives the MBS session configuration 208. The MBS session configuration 208 can be received at 204 or alternatively received any time before reception of MBS data 214. As such, the MBS session configuration 208 can be received in the RRC inactive state or RRC connected state and can be received through dedicated, broadcast, or multicast signaling and may be received through an SDT procedure. Furthermore, the UE 101 may receive the MBS session activation notification 304 (not pictured) or the MBS reception enabled message 504 (not pictured).

In addition to receiving at least the MBS session configuration 208, the UE 101 also receives a configuration area or cell list. The configuration area or cell list designates an area or cell list of one or more cells where inactive MBS reception is enabled in the RRC inactive state for the session ID associated with the MBS session configuration. As such, the BS 111 determines the configuration area or the cell list that is enabled for MBS reception for the session associated with the MBS session configuration 208. In this aspect, the cell list could be a single cell or a radio access network (RAN). For the configuration area or cell list, the UE 101 can use the MBS session configuration 208 to perform inactive MBS reception after changing cells to the new BS 111b as used with the serving BS 111a. As such, after changing from the serving BS 111a to the new BS 111b, the UE 101 can directly receive MBS data 214 in the RRC inactive state according to the MBS session configuration 208 received from the serving BS 111a.

As such, at 212 the UE 101 receives MBS data 214 from the serving BS 111a according to the MBS session configuration 208. At 1202 the UE 101 can perform a cell handover procedure or a cell re-selection procedure where the UE 101 connects to the new BS 111b. At 1204, the UE 101 can receive MBS data 214 based on the MBS session configuration 208 while the UE 101 is configured for the RRC inactive state and after connecting to the new BS 111b. The UE 101 receives MBS data 214 in accordance with the area configuration or cell list where the new BS 111b is in the configuration area or cell list of enabled MBS reception. The UE 101 can de-configure multicast MBS reception according to aspects previously described previously herein. Diagram 1200 provides mechanisms by which the UE 101 can directly receive MBS data 214 in the RRC inactive state after connecting to a new BS without additional signaling and according to a MBS session configuration 208 received from the previous serving BS.

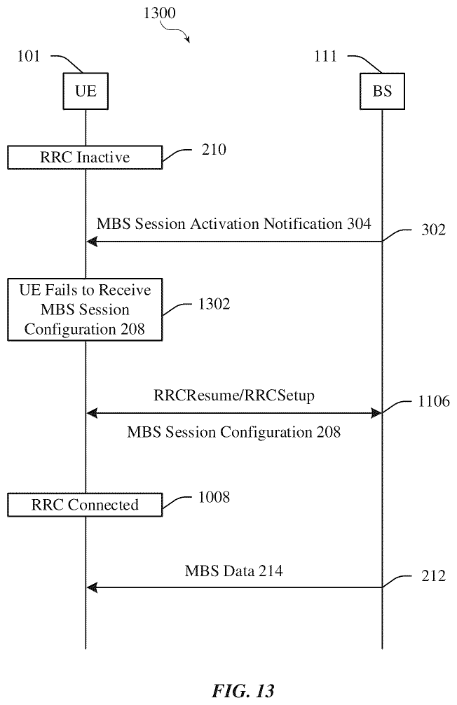

FIG. 13 illustrates diagram 1300 of MBS signaling in the RRC inactive state where the UE 101 fails to receive the MBS session configuration 208. In diagram 1300, the UE 101 can be the UE 101a or UE 101b of FIG. 1. The BS 111 can be the BS 111a or the BS 111b of FIG. 1. Diagram 1300, presumes the one or more conditions include at least that the UE 101 supports MBS reception in the RRC inactive state and that the BS 111 supports MBS data 214 transmission while the UE 101 is in the RRC inactive state. Diagram 1300 shows that the UE 101 fails to receive the MBS session configuration 208 at 1302 after the UE 101 is configured for the RRC inactive state at 210 and before receiving MBS data 214. As such, the UE 101 fails to receive the MBS session configuration 208 after receiving the MBS session activation notification 304 at 302. Alternatively the MBS session activation notification 304 may be received while the UE 101 is in the RRC active state, or the UE 101 may determine that the MBS session is active implicitly, for example, as described in FIG. 4.

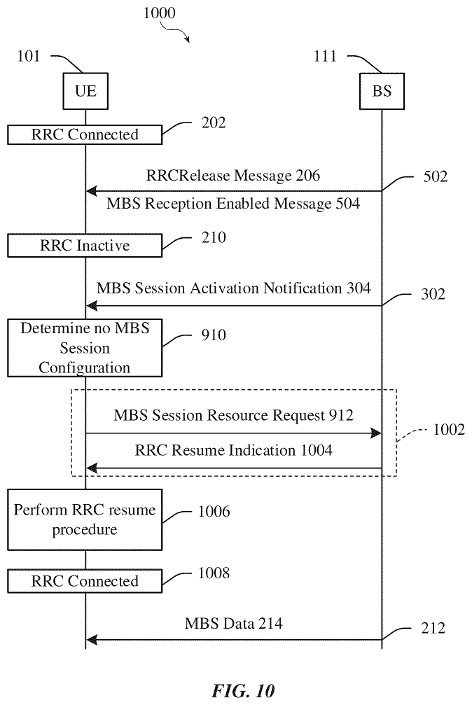

When the UE 101 fails to receive the MBS session configuration 208, the UE 101 determines or detects a MBS session failure. The UE 101 may fail to receive the MBS session configuration 208 according to aspects described previously herein. For example, the UE 101 may fail to receive the MBS session configuration 208 at act 204 of FIGS. 2-4 or act 804 of FIG. 8 when the UE 101 receives the RRCRelease message 206. The UE 101 may fail to receive the MBS session configuration 208 in the RRC inactive state at acts 506, 508 of FIGS. 5-6 or act 704 of FIG. 7 or act 914 of FIG. 9, or in conjunction with act 1002 of FIG. 10. Thus, the MBS session failure can be detected when the UE fails to receive the MBS session configuration 208 after configuring the RRC inactive state. Additionally, the MBS session failure can be detected when the UE 101 connects to a BS that does not provide the MBS session configuration after configuring the RRC inactive state. Furthermore, the MBS session failure can be detected when the UE 101 receives a MBS session configuration 208 associated with a session ID that is different than a session ID of the MBS session activation notification 304.

After detecting or determining the MBS session failure or failing to receive the MBS session configuration 208, the UE 101 can perform a RRC resume procedure or a RRC setup procedure. The UE 101 can receive the MBS session configuration as part of or in response to performing the RRC resume or RRC setup procedure at 1106. After performing the RRC resume or RRC setup procedure, the UE 101 can configure the RRC connected state at 1008 and subsequently receive the MBS data 214 while configured for the RRC connected state.

Diagram 1300 provides mechanisms by which the UE 101 can fall back to the RRC connected state for MBS data 214 reception when the UE 101 detects a MBS failure when initiating MBS reception in the RRC inactive state.

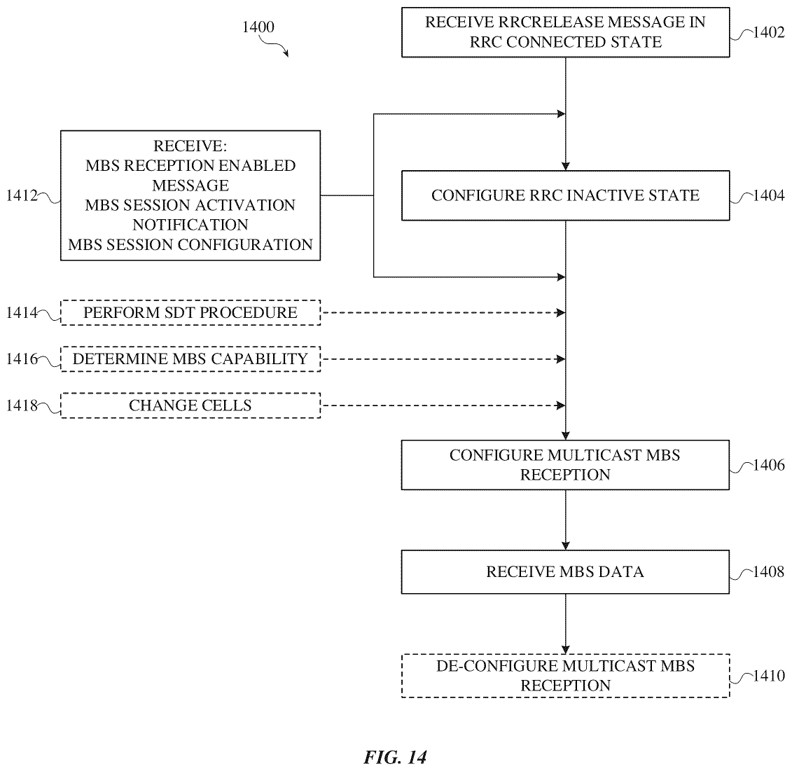

FIG. 14 illustrates a flow diagram of an example method 1400 for MBS signaling in the RRC inactive state for a UE. The example method 1400 may be performed, for example, by the UE 101 of FIG. 1.

At 1402 the method includes receiving a RRC release message while the UE is in the RRC connected state. FIGS. 2-4 and 12 at 202 and 204, FIGS. 5 at 202 and 502, FIGS. 6 at 202 and 602, FIGS. 7 at 202 and 502, FIGS. 8 at 202 and 804, and FIGS. 9-11 at 202 and 502 correspond to some aspects of act 1402.

At 1404 the UE can configure the RRC inactive state in response to receiving the RRC release message at 1402. FIGS. 2-12 at 210, correspond to some aspects of act 1404.

At 1412 the method includes receiving a MBS configuration data including one or more of a MBS session configuration comprising a session ID for RRC inactive state MBS reception, an associated MBS reception enabled message, or a MBS session activation notification. The MBS reception enabled message can indicate to the UE that a BS that the UE is connected to supports RRC inactive state MBS reception. The MBS session activation notification can indicate to the UE that the MBS session for RRC inactive state MBS reception is activated. The MBS configuration data can be received by the UE 101 before configuring the RRC inactive state or after configuring the RRC inactive state. In some aspects the UE determines the BS is enabled for RRC inactive state MBS messaging and or that the MBS session is active implicitly (implicit notification). FIGS. 2 and 3 at 204, FIGS. 4 at 204 and 402, FIGS. 5 at 502, 506, 508, and 510, FIGS. 6 at 506, 508, and 510, FIGS. 7 at 502, 702, and 704, FIG. 8 at 804, FIGS. 9-11 at 502 and 302, FIG. 12 at 204, and FIGS. 13 at 302 and 1106, correspond to some aspects of act 1412.

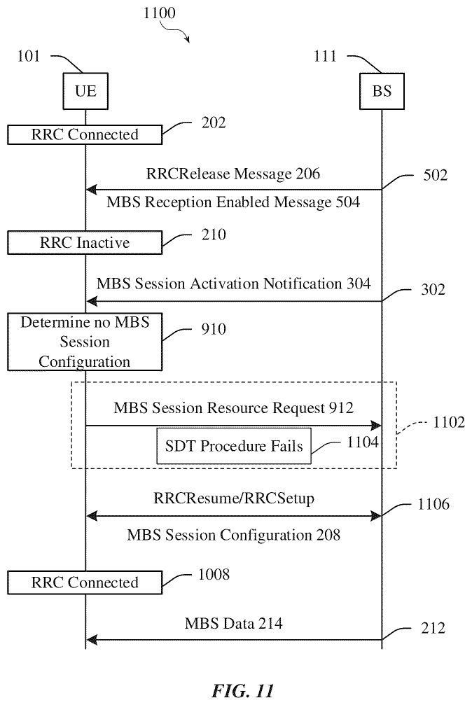

At 1414, the method includes optionally performing a SDT procedure. The SDT procedure can be performed to request the MBS session configuration if the UE determines that the UE does not have a valid MBS session configuration. As such, the UE can transmit a MBS session resource request and can receive the MBS session configuration in response. Alternatively, the UE can receive an indication to perform a RRC resume procedure, or the UE can determine that the SDT procedure failed and perform a RRC resume procedure or RRC setup procedure autonomously. FIG. 9 at 914, FIG. 10 at 1102-1008, and FIGS. 11 at 1102, 1106, and 1008, correspond to some aspects of act 1414.

At 1416, the method includes optionally performing a MBS capability procedure. The UE can determine the MBS capability of the UE to then determine if the UE supports RRC inactive state MBS reception and subsequently receive one or more of the MBS configuration data described at 1412. As such, act 1416 can be performed prior to acts described at 1412. FIG. 6 at 604 corresponds to some aspects of act 1416.

At 1418, the method includes optionally changing cells by performing a cell handover procedure or a cell re-selection procedure. As such, the UE can use the MBS session configuration received from a serving BS after connecting to a new BS while the UE 101 is in the RRC inactive state. FIG. 12 at 1202 corresponds to some aspects of act 1418.

At 1406, the method includes configuring multicast MBS reception. The UE can configure multicast MBS reception while the UE is configured for the RRC inactive state. In other examples, the UE can configure multicast MBS reception after the UE transitions to the RRC connected state according to a MBS session configuration received while the UE was in the RRC inactive state, RRC connected state, or received during a RRC resume procedure. The multicast MBS reception is configured based on the MBS session configuration. FIGS. 2, 3, and 8 at 210, FIGS. 4-7, and 9 at 406, FIGS. 10 at 1002, 1006, and 1008, FIGS. 11 at 1102, 1106, and 1008, FIGS. 12 at 204 and 210, and FIGS. 13 at 1106 and 1008, correspond to some aspects of act 1406.

At 1408, the method includes receiving MBS data. The MBS data corresponds to the MBS session configuration and can be received while the UE is in the RRC inactive state or the RRC connected state. FIGS. 2-13 at 212 and FIG. 12 at 1204, correspond to some aspects of act 1408.

At 1410, the method includes optionally de-configuring multicast MBS reception. Multicast MBS reception can be de-configured according to signaling such as a MBS session deactivation notification, upon performing a cell change procedure, receiving a broadcast configuration indicating de-configuration, or the like. FIGS. 2, 4, 7, and 8 at 220, and FIGS. 3 at 302, 304, and 406, correspond to some aspects of act 1410.

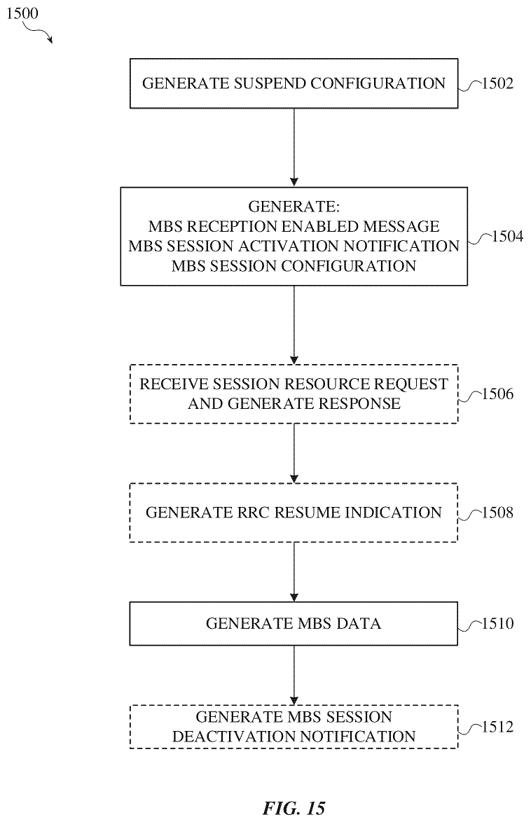

FIG. 15 illustrates a flow diagram of an example method 1500 for MBS signaling for a BS while a UE is in the RRC inactive state. The example method 1500 may be performed, for example, by the BS 111a or BS 111b of FIG. 1.

At 1502 the method includes generating a suspend configuration indicating to a UE to configure a RRC inactive state. FIGS. 2-4 and 12 at 204, FIGS. 5, 7, and 9-11 at 502, FIG. 6 at 602, and FIG. 8 at 804, correspond to some aspects of act 1502.

At 1504, the method includes generating MBS configuration data including one or more of a MBS session configuration comprising a session ID for RRC inactive state MBS reception, an associated MBS reception enabled message, or a MBS session activation notification. The MBS reception enabled message can indicate to a UE that the BS support RRC inactive state MBS reception for the UE. The MBS session activation notification can indicate to the UE that the MBS session for RRC inactive state MBS reception is activated. In some aspects, one or more of the MBS configuration data is included with the messaging for the suspend configuration at 1502. FIGS. 2 and 3 at 204, FIGS. 4 at 204 and 402, FIGS. 5 at 502, 506, 508, and 510, FIGS. 6 at 506, 508, and 510, FIGS. 7 at 502, 702, and 704, FIG. 8 at 804, FIGS. 9-11 at 502 and 302, FIG. 12 at 204, and FIGS. 13 at 302 and 1106, correspond to some aspects of act 1504.

At 1506, the method includes optionally receiving a session resource request as part of a SDT procedure. In response, the method can include generating a MBS session configuration or a RRC resume request. The session resource request indicates that the requesting UE does not have a MBS session configuration corresponding, for example, to a session ID of a MBS session activation notification. FIG. 9 at 914, FIG. 10 at 1102-1008, and FIGS. 11 at 1102, 1106, and 1008, correspond to some aspects of act 1506.

At 1508, the method includes optionally generating a RRC resume indication. The BS can determine to generate the RRC resume indication if the BS determines the UE should receive MBS data in the RRC connected state. FIG. 10 at 1002, and FIG. 13 at 1106, correspond to some aspects of act 1508.

At 1510, the method includes generating MBS data. The MBS data can be transmitted to the UE while the UE is in the RRC inactive state or the RRC connected state. FIGS. 2-13 at 212 and FIG. 12 at 1204, correspond to some aspects of act 1510.

At 1512, the method includes optionally generating a MBS session deactivation notification indicating to the UE that RRC inactive state MBS reception is terminated. FIGS. 2, 4, 7, and 8 at 220, and FIGS. 3 at 302, 304, and 406, correspond to some aspects of act 1512.

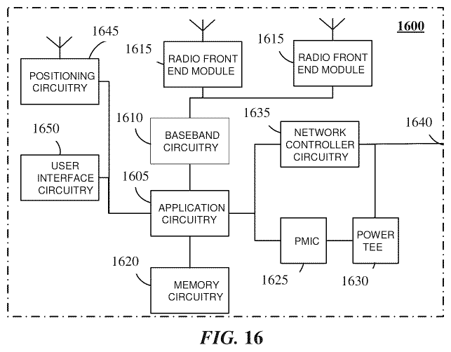

FIG. 16 illustrates an example of infrastructure equipment 1600 in accordance with various aspects. The infrastructure equipment 1600 (or “system 1600”) may be implemented as a base station, radio head, RAN node such as the BS 111 of FIG. 1 and/or any other element/component/device discussed herein. In other examples, the system 1600 could be implemented in or by a UE such as UE 101 of FIG. 1. In yet other aspects, some features of the system 1600 could be implemented in or by the first BS 111a or the second BS 111b of FIG. 12.

The system 1600 includes application circuitry 1605, baseband circuitry 1610, one or more radio front end modules (RFEMs) 1615, memory circuitry 1620 (including a memory interface), power management integrated circuitry (PMIC) 1625, power tee circuitry 1630, network controller circuitry 1635, network interface connector 1640, satellite positioning circuitry 1645, and user interface 1650. In some aspects, the device of system 1600 may include additional elements/components/devices such as, for example, memory/storage, display, camera, sensor, or input/output (I/O) interface. In other aspects, the components/devices described below may be included in more than one device. For example, said circuitries may be separately included in more than one device for CRAN, vBBU, or other like implementations.

The baseband circuitry 1610 can be used to configure the MBS reception enabled message, the MBS session activation notification, or the MBS session configuration by BS 111 described herein. Baseband circuitry 1610 can be used to receive the MBS reception enabled message, the MBS session activation notification, or the MBS session configuration by the UE 101.

Application circuitry 1605 includes circuitry such as, but not limited to one or more processors (or processor cores), processing circuitry, cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 1605 may be coupled with or may include memory/storage elements/components/devices and may be configured to execute instructions stored in the memory/storage to enable various applications or operating systems to run on the system 1600. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 1605 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some aspects, the application circuitry 1605 may comprise, or may be, a special-purpose processor/controller to operate according to the various aspects herein. As examples, the processor(s) of application circuitry 1605 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 1600 may not utilize application circuitry 1605, and instead may include a special-purpose processor/controller to process IP data received from an EPC or 5GC, for example.

User interface 1650 may include one or more user interfaces designed to enable user interaction with the system 1600 or peripheral component or device interfaces designed to enable peripheral component or device interaction with the system 1600. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component or device interfaces may include, but are not limited to, a nonvolatile memory port, a universal serial bus (USB) port, an audio jack, a power supply interface, etc.

The components or devices shown by FIG. 16 may communicate with one another using interface circuitry, that is communicatively coupled to one another, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

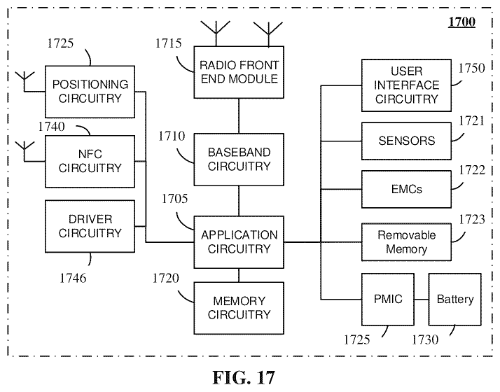

FIG. 17 illustrates an example of a platform 1700 (or “device 1700”) in accordance with various aspects. In aspects, the platform 1700 may be suitable for use as the UE 101 of FIG. 1, and/or any other element/component/device discussed herein such as the BS 111, first BS 111a, or second BS 111b. The platform 1700 may include any combinations of the components or devices shown in the example. The components or devices of platform 1700 may be implemented as integrated circuits (ICs), portions thereof, discrete electronic devices, or other modules, logic, hardware, software, firmware, or a combination thereof adapted in the platform 1700, or as components or devices otherwise incorporated within a chassis of a larger system. The block diagram of FIG. 17 is intended to show a high level view of components or devices of the platform 1700. However, some of the components or devices shown may be omitted, additional components or devices may be present, and different arrangement of the components or devices shown may occur in other implementations.

Application circuitry 1705 includes circuitry such as, but not limited to one or more processors (or processor cores), memory circuitry 1720 (which includes a memory interface), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 1705 may be coupled with or may include memory/storage elements/component/device and may be configured to execute instructions stored in the memory/storage to enable various applications or operating systems to run on the system 1700. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

As examples, the processor(s) of application circuitry 1705 may include a general or special purpose processor, such as an A-series processor (e.g., the A13 Bionic), available from Apple® Inc., Cupertino, CA or any other such processor. The processors of the application circuitry 1705 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 1705 may be a part of a system on a chip (SoC) in which the application circuitry 1705 and other components or devices are formed into a single integrated circuit, or a single package.

The baseband circuitry or processor 1710 may be implemented, for example, as a solder-down substrate including one or more integrated circuits, a single packaged integrated circuit soldered to a main circuit board or a multi-chip module containing two or more integrated circuits. Furthermore, the baseband circuitry or processor 1710 may cause transmission of various resources.

The platform 1700 may also include interface circuitry (not shown) that is used to connect external devices with the platform 1700. The interface circuitry may communicatively couple one interface to another. The external devices CONNECTED to the platform 1700 via the interface circuitry include sensor circuitry 1721 and electro-mechanical components (EMCs) 1722, as well as removable memory devices coupled to removable memory circuitry 1723.

A battery 1730 may power the platform 1700, although in some examples the platform 1700 may be mounted deployed in a fixed location, and may have a power supply coupled to an electrical grid. The battery 1730 may be a lithium ion battery, a metal-air battery, such as a zinc-air battery, an aluminum-air battery, a lithium-air battery, and the like. In some implementations, such as in V2X applications, the battery 1730 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium or a non-transitory computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components or devices, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

A UE or a BS, for example the UE 101 or BS 111 of FIG. 1 can comprise a memory interface and processing circuitry communicatively coupled to the memory interface configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 is a baseband processor of a user equipment (UE), comprising: one or more processors configured to: receive a suspend configuration in a radio resource control (RRC) message; configure the UE for a RRC inactive state based on the suspend configuration; receive a multicast and broadcast services (MBS) session configuration before or after configuring the RRC inactive state; configure multicast MBS reception based on the MBS session configuration; and receive multicast MBS data based on the MBS session configuration while the UE is configured for the RRC inactive state.

Example 2 is the baseband processor of example 1, further configured to receive a MBS session activation notification before receiving the multicast MBS data.

Example 3 is the baseband processor of example 2, wherein the MBS session activation notification is received before or after configuring multicast MBS reception.

Example 4 is the baseband processor of any of examples 1-3, wherein the MBS session configuration and the MBS session activation notification are included in the RRC message comprising the suspend configuration.

Example 5 is the baseband processor of example 1, wherein the MBS session configuration is included in the RRC message comprising the suspend configuration.

Example 6 is the baseband processor of any of examples 1-5, wherein the MBS session configuration is received in a dedicated RRC message.

Example 7 is the baseband processor of example 1, further configured to receive a MBS session deactivation notification, and de-configure multicast MBS reception based on the MBS session deactivation notification.

Example 8 is the baseband processor of example 7, wherein the MBS session deactivation notification is received in a dedicated RRC message.

Example 9 is the baseband processor of example 1, further configured to receive a broadcast configuration and de-configure multicast MBS reception based on the broadcast configuration.

Example 10 is the baseband processor of example 1, wherein the one or more processors further configure a MBS timer and reception time threshold; and de- configure multicast MBS reception when multicast MBS data is not received before the MBS timer exceeds the reception time threshold.

Example 11 is the baseband processor of example 1, further configured to perform a cell reselection procedure and de-configure multicast MBS reception in response to performing the cell reselection procedure.

Example 12 is the baseband processor of example 1, wherein the RRC message comprising the suspend configuration further comprises an indication that inactive MBS reception is enabled by a base station (BS).

Example 13 is the baseband processor of example 1, further configured to determine a MBS capability of the UE and receive the MBS session configuration based on the MBS capability.

Example 14 is the baseband processor of any of examples 11-12, wherein the MBS session configuration is received by a broadcast signaling after the UE is configured for the RRC inactive state; receive a MBS session activation notification after receiving the MBS session configuration; and configure multicast MBS reception after receiving the MBS session activation notification.

Example 15 is the baseband processor of any of examples 11-12, further configured to receive a MBS session activation notification in after configuring the RRC inactive state and receive the MBS session configuration by a broadcast signaling after receiving the MBS session activation notification.

Example 16 is the baseband processor of any of examples 11-12, further configured to receive a system information block (SIB) or a MBS control channel (MCCH) message by a broadcast signaling; and when the SIB or MCCH message comprises the MBS session configuration, a MBS session of the MBS session configuration is activated and the one or more processors further configure multicast MBS reception in response to receiving the SIB or MCCH message; or when the SIB or MCCH message does not comprise the MBS session configuration, a MBS session of the MBS session configuration is deactivated and the one or more processors further de-configures multicast MBS reception in response to receiving the SIB or MCCH message.

Example 17 is the baseband processor of any of examples 11-12, further configured to receive the MBS session configuration in a system information block (SIB) or a MBS control channel (MCCH) message by a broadcast signaling.

Example 18 is the baseband processor of any of examples 11-12, further configured to receive a system information block (SIB) or a MBS control channel (MCCH) message by a broadcast signaling, wherein the SIB or the MCCH message includes a MBS session activation notification or a MBS session deactivation notification; and configure multicast MBS reception in response to receiving the MBS session activation notification; or de-configure multicast MBS reception based on the MBS session deactivation notification.

Example 19 is an apparatus of a user equipment (UE), comprising: one or more processors configured to: receive a suspend configuration in a radio resource control (RRC) message wherein the RRC message includes an indication that inactive multicast and broadcast services (MBS) reception is enabled by a base station (BS); configure the UE for a RRC inactive state based on the suspend configuration; receive a MBS activation notification and a MBS session configuration; configure multicast MBS reception based on the MBS session configuration; and receive multicast MBS data based on the MBS session configuration and after receiving the MBS activation notification while the UE is configured for the RRC inactive state.

Example 20 is the apparatus of example 19, wherein the MBS session configuration is received in a dedicated signaling or a broadcast signaling.

Example 21 is the apparatus of example 20, wherein the MBS session configuration is received before configuring the RRC inactive state.

Example 22 is the apparatus of example 20, further configured to determine a MBS capability of the UE and wherein multicast MBS reception is configured based on the MBS capability of the UE.

Example 23 is the apparatus of example 19, wherein the MBS activation notification and the MBS session configuration are received in the RRC message comprising the suspend configuration.

Example 24 is the apparatus of example 23, wherein the MBS activation notification is received in multicast signaling and the one or more processors are further configured to: receive a MBS session deactivation notification; and de-configure multicast MBS reception based on the MBS session deactivation notification.

Example 25 is the apparatus of example 19, further configured to receive a MBS control channel (MCCH) message, wherein the MCCH message comprises the MBS activation notification or a MBS deactivation notification; and configure multicast MBS reception when the MCCH message comprises the MBS activation notification; or de-configure multicast MBS reception when the MCCH message comprises the MBS deactivation notification.

Example 26 is the apparatus of example 19, further configured to receive a MBS paging message, wherein the MBS paging message comprises the MBS activation notification or a MBS deactivation notification; and configure multicast MBS reception when the MBS paging message comprises the MBS activation notification; or de-configure multicast MBS reception when the MBS paging message comprises the MBS deactivation notification.

Example 27 is the apparatus of example 26, wherein the MBS paging message is a multicast specific paging message to indicate the MBS activation notification or the MBS deactivation notification.

Example 28 is the apparatus of example 19, further configured to receive a layer 1 (L1) or layer 2 (L2) multicast MBS indication, wherein the L1 or L2 multicast MBS indication comprises the MBS activation notification or a MBS deactivation notification; and configure multicast MBS reception when the L1 or L2 multicast MBS indication comprises the MBS activation notification; or de-configure multicast MBS reception when the L1 or L2 multicast MBS indication comprises the MBS deactivation notification.

Example 29 is the apparatus of example 28, wherein the L1 or L2 multicast MBS indication is a MBS medium access control (MAC) control element (CE), and the MBS MAC CE indicates MBS session information for one or more MBS sessions.

Example 30 is a baseband processor of a user equipment (UE), comprising: one or more processors configured to: receive a suspend configuration in a radio resource control (RRC) message wherein the RRC message includes an indication that inactive multicast and broadcast services (MBS) reception is enabled by a base station (BS); configure the UE for a RRC inactive state based on the suspend configuration; receive a MBS activation notification, a MBS session configuration, and a RRC resume indication after configuring the RRC inactive state; configure the UE for a RRC connected state based on the RRC resume indication; configure multicast MBS reception based on the MBS session configuration; and receive multicast MBS data based on the MBS session configuration while the UE is configured for the RRC connected state.

Example 31 is a baseband processor of a user equipment (UE), comprising: one or more processors configured to: receive a suspend configuration in a radio resource control (RRC) message wherein the RRC message includes an indication that inactive multicast and broadcast services (MBS) reception is enabled by a base station (BS); configure the UE for a RRC inactive state based on the suspend configuration; receive a MBS activation notification after configuring the UE for the RRC inactive state; perform a small data transmission (SDT) procedure and receive a MBS session configuration in response to performing the SDT procedure; and configure multicast MBS reception based on the MBS session configuration; and receive multicast MBS data based on the MBS session configuration.

Example 32 is the baseband processor of example 31, wherein the SDT procedure includes: generating a MBS session resource request; receiving the MBS session configuration in response to generating the MBS session resource request; and receiving the multicast MBS data while the UE is configured for the RRC inactive state.

Example 33 is the baseband processor of example 31, wherein the SDT procedure includes: generating a MBS session resource request; receiving the MBS session configuration and a RRC resume indication in response to generating the MBS session resource request; configure the UE for a RRC connected state based on the RRC resume indication; and receiving the multicast MBS data while the UE is configured for the RRC connected state.

Example 34 is the baseband processor of example 31, further configured to detect that the SDT procedure failed; perform a RRC resume procedure or RRC setup procedure in response to detecting that the SDT procedure failed; receive the MBS session configuration in response to performing the RRC resume procedure or RRC setup procedure; configure the UE for a RRC connected state based on the RRC resume procedure or RRC setup procedure; and receive the multicast MBS data based on the MBS session configuration while the UE is configured for the RRC connected state.

Example 35 is the baseband processor of any of examples 31-34, wherein the one or more processors are further configured to determine that the UE does not have the MBS session configuration after receiving the MBS activation notification; and subsequently perform the SDT procedure.

Example 36 is a baseband processor of a user equipment (UE), comprising: one or more processors configured to: receive a suspend configuration in a radio resource control (RRC) message; configure the UE for a RRC inactive state based on the suspend configuration; receive a multicast and broadcast services (MBS) session configuration and a MBS activation notification; perform a cell handover procedure or a cell re-selection procedure where the UE connects to a new base station (BS); and receive multicast MBS data based on the MBS session configuration while the UE is configured for the RRC inactive state and after connecting to the new BS.

Example 37 is the baseband processor of example 36, wherein the MBS session configuration comprises a configuration area of enabled MBS reception for a session associated with the MBS session configuration; and the new BS is in the configuration area of enabled MBS reception.

Example 38 is the baseband processor of example 36, wherein the MBS session configuration comprises a cell list indicating one or more cells enabled for MBS reception for a session associated with the MBS session configuration; and the new BS is comprised in the cell list indicating one or more cells.

Example 38 is the baseband processor of example 38, wherein the cell list indicating one or more cells indicates a single cell or a radio access network (RAN).

Example 40 is a baseband processor of a user equipment (UE), comprising: one or more processors configured to: detect a multicast and broadcast services (MBS) session failure after receiving a MBS activation notification while the UE is configured for a RRC inactive state; perform a RRC resume procedure or a RRC setup procedure after detecting the MBS session failure; receive a MBS session configuration in response to performing the RRC resume procedure or RRC setup procedure; configure the UE for a RRC connected state based on the RRC resume procedure or RRC setup procedure; and receive multicast MBS data based on the MBS session configuration while the UE is configured for the RRC connected state.

Example 41 is the baseband processor of example 40, wherein the MBS session failure is detected when the UE fails to receive the MBS session configuration after configuring the RRC inactive state.

Example 42 is the baseband processor of example 40, wherein the MBS session failure is detected when the UE connects to a cell that does not provide the MBS session configuration after configuring the RRC inactive state.

Example 43 is the baseband processor of example 40, wherein the MBS session failure is detected when the UE receives a MBS configuration associated with a session ID that is different than a session ID of the MBS activation notification.

Example 44 is a baseband processor of a base station (BS), comprising: one or more processors configured to: generate a suspend configuration in a radio resource control (RRC) message and generate a multicast and broadcast services (MBS) session configuration and a MBS activation notification wherein the MBS session configuration and MBS activation notification are for RRC inactive state signaling; and after generating the MBS session configuration and MBS activation notification, generate multicast MBS data based on the MBS session configuration for one or more user equipment's (UEs) in an RRC inactive state.

Example 45 is the baseband processor of example 44, wherein the MBS session configuration and MBS activation notification are included with the suspend configuration in the RRC message.

Example 46 is the baseband processor of example 44, further configured to generate an indication that inactive MBS reception is enabled and include the indication in the RRC message.

Example 47 is the baseband processor of example 44, further configured generate the MBS session configuration in a system information block (SIB) or a MBS control channel (MCCH) message.

Example 48 is the baseband processor of example 44, wherein the MBS session configuration is comprised in dedicated signaling.

Example 49 is the baseband processor of example 44, wherein the MBS session configuration is comprised in broadcast signaling.

Example 50 is the baseband processor of example 44, wherein the one or more processors are further configured to: receive a small data transmission (SDT) with a MBS session resource request after generating the MBS activation notification; and generate the MBS session configuration after receiving the MBS session resource request.

Example 51 is the baseband processor of example 44, wherein the MBS session configuration comprises a configuration area for enabled MBS reception for a session associated with the MBS session configuration.

Example 52 is the baseband processor of example 44, wherein the MBS session configuration comprises a cell list indicating one or more cells enabled for MBS reception for a session associated with the MBS session configuration.

Example 53 is the baseband processor of example 52, wherein the cell list indicating one or more cells indicates a single cell or a plurality of cells.

A method as substantially described herein with reference to each or any combination substantially described herein, comprised in examples 1-53, and in the Detailed Description.

A non-transitory computer readable medium as substantially described herein with reference to each or any combination substantially described herein, comprised in examples 1-53, and in the Detailed Description.

A wireless device configured to perform any action or combination of actions as substantially described herein, comprised in examples 1-53, and in the Detailed Description.

An integrated circuit configured to perform any action or combination of actions as substantially described herein, comprised in examples 1-53, and in the Detailed Description.

An apparatus configured to perform any action or combination of actions as substantially described herein, comprised in examples 1-53, and in the Detailed Description.

A baseband processor configured to perform any action or combination of actions as substantially described herein, comprised in examples 1-53, and in the Detailed Description.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communication media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal or apparatus.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components or devices (assemblies, devices, circuits, systems, etc.), the terms (including a reference to a “means”) used to describe such components or devices are intended to correspond, unless otherwise indicated, to any component, device, or structure which performs the specified function of the described component or device (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The present disclosure is described with reference to the attached drawing figures, wherein like reference numerals are used to refer to like elements, devices, or components throughout, and wherein the illustrated structures and devices are not necessarily drawn to scale. As utilized herein, terms “device,” “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable or non-transitory computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor of a user equipment (UE), comprising:
one or more processors configured to:
receive a suspend configuration in a radio resource control (RRC) message;
configure the UE for a RRC inactive state based on the suspend configuration;
receive a multicast and broadcast services (MBS) session configuration before or after configuring the RRC inactive state;
configure multicast MBS reception based on the MBS session configuration; and
receive multicast MBS data based on the MBS session configuration while the UE is configured for the RRC inactive state.

2. The baseband processor of claim 1, further configured to receive a MBS session activation notification before receiving the multicast MBS data.

3. The baseband processor of claim 2, wherein the MBS session activation notification is received before or after configuring multicast MBS reception.

4. The baseband processor of claim 1, wherein the MBS session configuration and the MBS session activation notification are included in the RRC message comprising the suspend configuration.

5. The baseband processor of claim 1, further configured to receive a broadcast configuration and de-configure multicast MBS reception based on the broadcast configuration.

6. The baseband processor of claim 1, wherein the one or more processors further configure a MBS timer and reception time threshold; and
de-configure multicast MBS reception when multicast MBS data is not received before the MBS timer exceeds the reception time threshold.

7. The baseband processor of claim 1, further configured to perform a cell reselection procedure and de-configure multicast MBS reception in response to performing the cell reselection procedure.

8. The baseband processor of claim 7, wherein the MBS session configuration is received by a broadcast signaling after the UE is configured for the RRC inactive state;
receive a MBS session activation notification after receiving the MBS session configuration; and
configure multicast MBS reception after receiving the MBS session activation notification.

9. The baseband processor of claim 7, further configured to receive a MBS session activation notification in after configuring the RRC inactive state and receive the MBS session configuration by a broadcast signaling after receiving the MBS session activation notification.

10. The baseband processor of claim 1, wherein the RRC message comprising the suspend configuration further comprises an indication that inactive MBS reception is enabled by a base station (BS).

11. The baseband processor of claim 10, further configured to receive a system information block (SIB) or a MBS control channel (MCCH) message by a broadcast signaling; and
when the SIB or MCCH message comprises the MBS session configuration, a MBS session of the MBS session configuration is activated and the one or more processors further configure multicast MBS reception in response to receiving the SIB or MCCH message; or
when the SIB or MCCH message does not comprise the MBS session configuration, a MBS session of the MBS session configuration is deactivated and the one or more processors further de-configures multicast MBS reception in response to receiving the SIB or MCCH message.

12. A user equipment (UE), comprising:
a memory circuit; and
one or more processors coupled to the memory circuitry, and when executing instructions stored in the memory circuit, cause the UE:
receive a suspend configuration in a radio resource control (RRC) message wherein the RRC message includes an indication that inactive multicast and broadcast services (MBS) reception is enabled by a base station (BS);
configure the UE for a RRC inactive state based on the suspend configuration;
receive a MBS activation notification and a MBS session configuration;
configure multicast MBS reception based on the MBS session configuration; and
receive multicast MBS data based on the MBS session configuration and after receiving the MBS activation notification while the UE is configured for the RRC inactive state.

13. The apparatus of claim 12, wherein the MBS activation notification and the MBS session configuration are received in the RRC message comprising the suspend configuration.

14. The apparatus of claim 13, wherein the MBS activation notification is received in multicast signaling and the one or more processors are further configured to:
receive a MBS session deactivation notification; and
de-configure multicast MBS reception based on the MBS session deactivation notification.

15. The apparatus of claim 12, further configured to receive a MBS paging message, wherein the MBS paging message comprises the MBS activation notification or a MBS deactivation notification; and
configure multicast MBS reception when the MBS paging message comprises the MBS activation notification; or
de-configure multicast MBS reception when the MBS paging message comprises the MBS deactivation notification.

16. The apparatus of claim 15, wherein the MBS paging message is a multicast specific paging message to indicate the MBS activation notification or the MBS deactivation notification.

17. A method for a user equipment (UE), comprising:
receiving a suspend configuration in a radio resource control (RRC) message wherein the RRC message includes an indication that inactive multicast and broadcast services (MBS) reception is enabled by a base station (BS);
configuring the UE for a RRC inactive state based on the suspend configuration;
receiving a MBS activation notification after configuring the UE for the RRC inactive state;
performing a small data transmission (SDT) procedure and receive a MBS session configuration in response to performing the SDT procedure; and
configure multicast MBS reception based on the MBS session configuration; and
receiving multicast MBS data based on the MBS session configuration.

18. The method of claim 17, wherein the SDT procedure includes:
generating a MBS session resource request;
receiving the MBS session configuration in response to generating the MBS session resource request; and
receiving the multicast MBS data while the UE is configured for the RRC inactive state.

19. The method of claim 17, wherein the SDT procedure includes:
generating a MBS session resource request;
receiving the MBS session configuration and a RRC resume indication in response to generating the MBS session resource request;
configure the UE for a RRC connected state based on the RRC resume indication; and
receiving the multicast MBS data while the UE is configured for the RRC connected state.

20. The method of claim 17, further configured to detect that the SDT procedure failed;
perform a RRC resume procedure or RRC setup procedure in response to detecting that the SDT procedure failed;
receive the MBS session configuration in response to performing the RRC resume procedure or RRC setup procedure;
configure the UE for a RRC connected state based on the RRC resume procedure or RRC setup procedure; and
receive the multicast MBS data based on the MBS session configuration while the UE is configured for the RRC connected state.
